(19) United States
(12) Patent Application Publication
(10) Pub. No.: US 2023/0096491 A1
(43) Pub. Date: Mar. 30, 2023

(54) Gel Filled Connector For Large Gauge Wires

(71) Applicant: John Clifford, Indianapolis, IN (US)

(72) Inventor: John Clifford, Indianapolis, IN (US)

(21) Appl. No.: 17/486,513

(22) Filed: Sep. 27, 2021

(51) Int. Cl. H01R 9/22; H01R 13/523; H01B 7/285; H01B 3/46

(52) U.S. Cl. CPC H01R 9/223; H01R 13/523; H01B 7/285; H01B 3/465

(57) ABSTRACT

A gel filled electrical connector is disclosed and claimed. The connector has a base configured to house a gel fill insulating material and a plurality of 10-gauge or larger diameter wires; the base comprising a plurality of wire receptacles to receive a plurality of wires in a cavity in the base; a top cover sized to be securely and removably attached to the base, wherein the top cover comprises a plurality of wire connectors to strip insulation from the plurality of wire and to electrically connect the plurality of wires; and a gel deposited into the cavity to provide moisture resistance to the plurality of wires and plurality of wire connectors.

### PRIORITY CLAIM

The present application claims priority to U.S. provisional patent application No. 63/084,192, filed Sep. 28, 2020, titled “Gel Filled Connector for Large Gauge Wires.” The entire content of the identified provisional patent application is incorporated herein by reference.

### FIELD OF DISCLOSURE

This disclosure relates generally to gel filled electrical connectors. The gel filled connectors are used to splice or connect wires used, for example, in recreational vehicles and trailers. Crimp-type electrical terminals and connectors come in several varieties. Sizes/gauge ranges may be denoted by their color. Such connectors are suitable for any job where soldering is not needed or desired. Ring terminals would commonly be used in situations where you need a more secure connection than a fork terminal. The fork terminal is typically used in situations where ease of removal is more important than a secure connection. The fork terminals are typically bound with a screw or threaded post and a nut. Quick disconnect terminals come in both male and female varieties. They can be used together to create a connection. They can connect to existing connectors such as car audio speakers which often have male quick disconnect terminals. The gel filling provides protection for the wires and electrical connection against moisture intrusion and ultra violet damage.

### SUMMARY

The invention disclosed and claimed herein is a gel filled electrical connector 10 for wires 20, 30, having a diameter of about 2.59 mm or greater, corresponding to 10-gauge or larger-diameter wire. The sizes of wires 20, 30 are estimated by devices, also called gauges, which consist of plates of circular or oblong form having notches of different widths around their edges to receive wire and sheet metals of different thicknesses. Each notch is stamped with a number, and the wire or sheet, which fits a given notch, is stated to be of, say, No. 10, 11, 12, etc., of the wire gauge. One such wire gauge and current table is as follows:

| American Wire | Diameter | Diameter | Cross Sectional |
|---|---|---|---|
| Gauge (#AWG) | (inches) | (mm) | Area (mm²) |
| 0000 (4/0) | 0.460 | 11.7 | 107 |
| 000 (3/0) | 0.410 | 10.4 | 85.0 |
| 00 (2/0) | 0.365 | 9.27 | 67.4 |
| 0 (1/0) | 0.325 | 8.25 | 53.5 |
| 1 | 0.289 | 7.35 | 42.4 |
| 2 | 0.258 | 6.54 | 33.6 |
| 3 | 0.229 | 5.83 | 26.7 |
| 4 | 0.204 | 5.19 | 21.1 |
| 5 | 0.182 | 4.62 | 16.8 |
| 6 | 0.162 | 4.11 | 13.3 |
| 7 | 0.144 | 3.67 | 10.6 |
| 8 | 0.129 | 3.26 | 8.36 |
| 9 | 0.114 | 2.91 | 6.63 |
| 10 | 0.102 | 2.59 | 5.26 |

In some applications, wire sizes are specified as the cross sectional area of the wire, usually in square millimeters (mm²). Advantages of this system include the ability to readily calculate the physical dimensions or weight of wire, ability to take account of non-circular wire, and ease of calculation of electrical properties.

The gel connector 10 comprises a base 40 configured to house a gel fill insulating material 50, and to receive 10-gauge or larger diameter wires 20, 30. A top cover 60 is provided. Base 40 and cover 60 may be formed from any suitable material such as Nylon, polycarbonate, plastic, resin, etc. as is known in the art. Wire connectors 70a-c are mounted to the top cover 60 positioned to allow wire connectors 70a-c to engage wires 20, 30 so as to remove the insulating cover of the wires 20, 30 without damaging the conductive material in wires 20, 30. When the wires 20, 30 are inserted into the base 40, the top cover 60 is secured to the base 40 so that the wire connectors 70a-c pierce the plastic insulating cover 80 of the wires 20, 30 to be connected thereby providing a conductive connection between the two wires 20, 30. The top cover 60 is securely connected to the base 40 once the wires 20, 30 are inserted into the base 40 and secured to the wire connector 70.

The present invention provides an environmentally protected electrical connector. To protect the connector 10 from moisture and other corrosion, the connector assembly is filled with an environmental sealant 50. The environmental sealant 50 is preferably a hydrophobic dielectric to eliminate moisture and insulate wires 20, 30 and contacts wire connectors 70a-c. Gels 50 are preferred and most preferred are silicone gels. The gel 50 requires sufficient adhesion and forms an acceptable seal around the wire connectors 70a-c, wires 20, 30, and other parts of the connector 10 in the need for environmental protection. Various suitable gels are known to those of skill in the art. The gel sealant 50 should have sufficient hardness to provide lasting protection against environmental pollutants. The gel sealant 50 should be soft enough to be displaced by the connectors 70a-c and properly seal it according to the shape of the connector 10.

### BRIEF DESCRIPTION OF THE DRAWINGS

FIG. 1 is a top-view of the gel filled connector.

FIG. 2 is a side-view of the gel filled connector.

FIG. 3 is a bottom-view of the gel filled connector.

FIG. 4 is a top-view of the gel filled connector with two wires secured therein.

FIG. 5 is a bottom-view of the gel filled connector with two wires secured therein.

FIG. 6 is a perspective view of the gel filled connector.

FIG. 7 is a bottom-view of the gel filled connector.

FIG. 8 is a perspective view of the gel filled connector without the top cover.

FIG. 9 is a side-view of the gel filled connector.

FIG. 10 is an end-view schematic of the gel filled connector without the top cover.

FIG. 11 is a bottom-view the cover for the gel filled connector.

FIG. 12 is a side-view of the top cover.

FIG. 13 is a top-view of the top cover.

FIG. 14 is a perspective-view of the top cover.

### DETAILED DESCRIPTION

The devices and methods disclosed include one or more of the features, structures, methods, or combination thereof described. For example, a device or method may be implemented to include one or more of the features and/or processes described herein. Such device or method need not include all the features and/or processes described but may be implemented to include selected features and/or processes that provide useful structures and/or functionality. Various modifications and additions can be made to the disclosed embodiments. The scope of the present disclosure is not limited by the embodiments described but is defined by the claims set forth below and equivalents thereof.

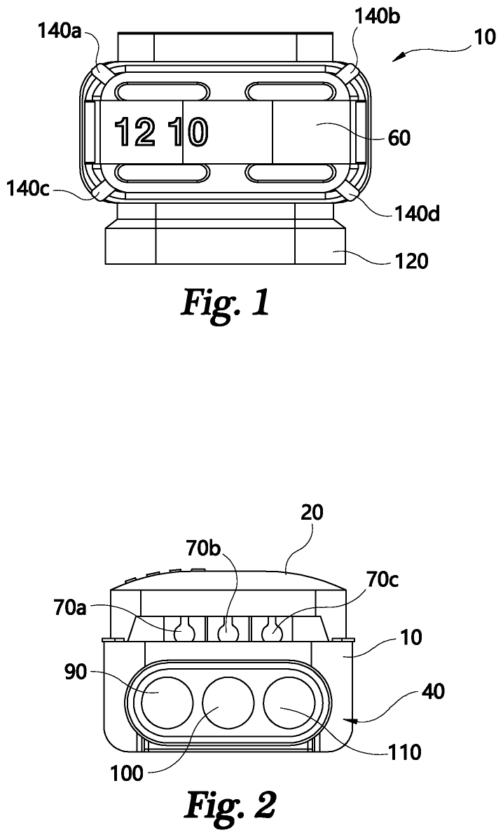

Referring to FIG. 1, the gel field connector 10 is shown. The connector 10 comprises a base 40, the top cover 60, and a plurality of wire receptacles 70a, 70b, 70c positioned within the cavity of the base 40. The cover 60 connects to the base 40 using legs 140a, 140b, 140c, and 140d. Legs 140a-d are sized to create an interference-type fit of the top cover 60 to base 40. In a preferred embodiment, legs 140a-d have extrusions (not shown) positioned and sized to be received in notches (not shown) in base 40. Legs 140a-d may engage the interior walls of base 40. Alternatively, legs 140a-d may engage outer walls of base 40. Base 40 and the top cover 60 may be manufactured from a plastic, resin, or other suitable material sufficient to provide a protective covering to the cavity of the base 40. Top cover 60 is removably secured to base 40. Flange 120 provides protection against external forces dislodging wires 20, 30. Legs 140a-d provide releasably connecting structures to secure top 60 to base 40. Any structure known in the art will suffice to secure top 60 to base 40.

FIG. 2 shows a side view of connector 10. Top cover 60 is securely connected to base 40 to provide an enclosure for wire connectors 70a, 70b, and 70c. Connectors 70a-c may be horseshoe shaped or of any other design known to those skilled in the art. Connectors 70a-c may be manufactured from tin or any other metallic, electrically conductive material. Although the embodiment shown in FIG. 2 has three connectors 70a-c, any number of connectors may be provided without departing from the scope of the invention disclosed and claimed. The cavity of the base 40 is filled with a gel to provide moisture resistance and protection for the wires connected their end. In a preferred embodiment gel 50 is hydrophobic.

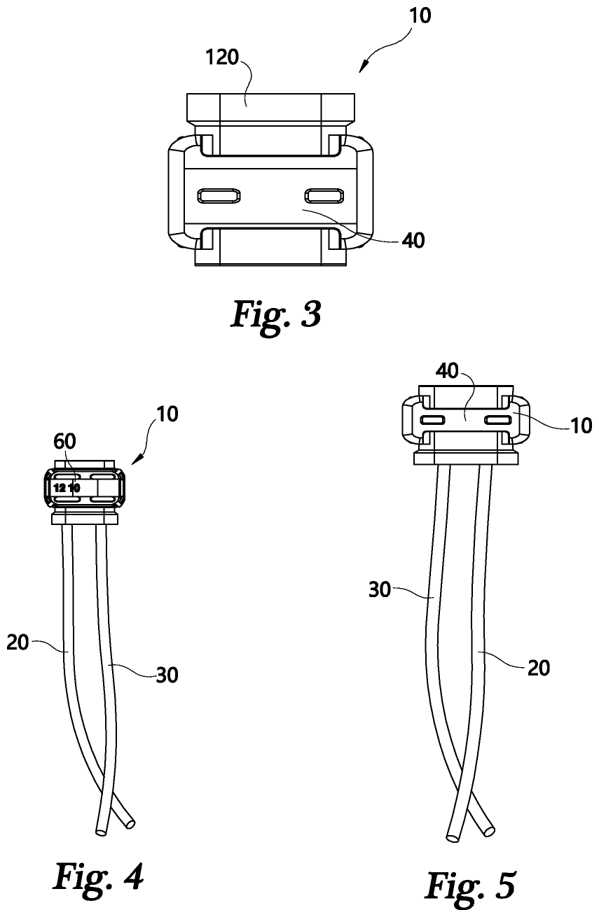

FIG. 3 shows a bottom view of the connector 10. Base 40 has a flange 120 that surrounds a plurality of wire receptacles 90, 100, 110. Wires 20, 30 are inserted into receptacles 90, 100, 110. FIG. 3 shows three receptacles, but any number of receptacles may be provided without departing from the scope of the invention disclosed and claimed.

FIG. 4 shows a top view of the connector 10 with wires 20, 30 connected therein. In this embodiment, cover 60 and legs 140a-d engage the inner walls of base 40. To connect the wires, the cover 60 is removed from the base 40, wires 20 and 30 are positioned within the cavity of the base 40. Wire connector 70a-c are attached to cover 60 so that when cover 60 is secured to base 40, connectors 70a-c strip away the insulation from wires 20, 30, and provide an electrical connection between the conductive material of wire 20 and the conductive material of wire 30. FIG. 5 shows a bottom view of the connector 10 with wires 20, 30 secured in the base 40.

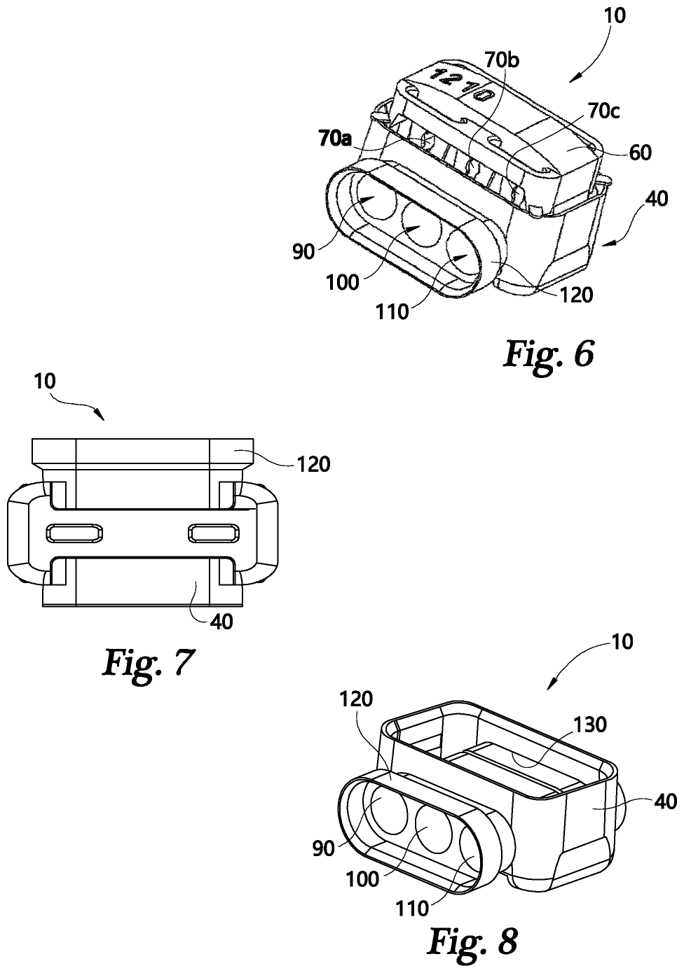

FIG. 6 shows connector 10 in perspective. Connector 10 comprises a top cover 60 removably connected to a base 40. In this embodiment, cover 60 is inserted into cavity of base 40 so that wire receptacle 70a-c are positioned to engage and electrically connect wires 20, 30. Wires 20, 30 enter through wire receptacles 90, 100, 110. When the wires 20, 30 are inserted into the base 40, wire connectors 70a-c pierce the insulated covering of the wires 20, 30 to make an electrical connection between wires 20 and 30. Flange 120 provides some protection for dislodging the wires 20, 30 once they are connected. FIG. 7 shows a bottom view of connector 10 including base 40 and flange 120.

FIG. 8 shows a perspective view of base 40 without top cover. Base 40 provides a cavity 130 suitable to receive wires 20, 30 and wire connectors 70a-c when top 60 is positioned in cavity 130. Wires 20, 30 may be inserted through wire receptacles 90, 100, 110 into cavity 130. Once inserted, the wire connector 70a-c, preferably secured to top 60, are positioned in the cavity 130. When top 60 is positioned and secured to base 40, wire connectors 70a-c strip away the insulated coating of wires 20, 30 and allow an electrical connection to be formed between wires 20, 30.

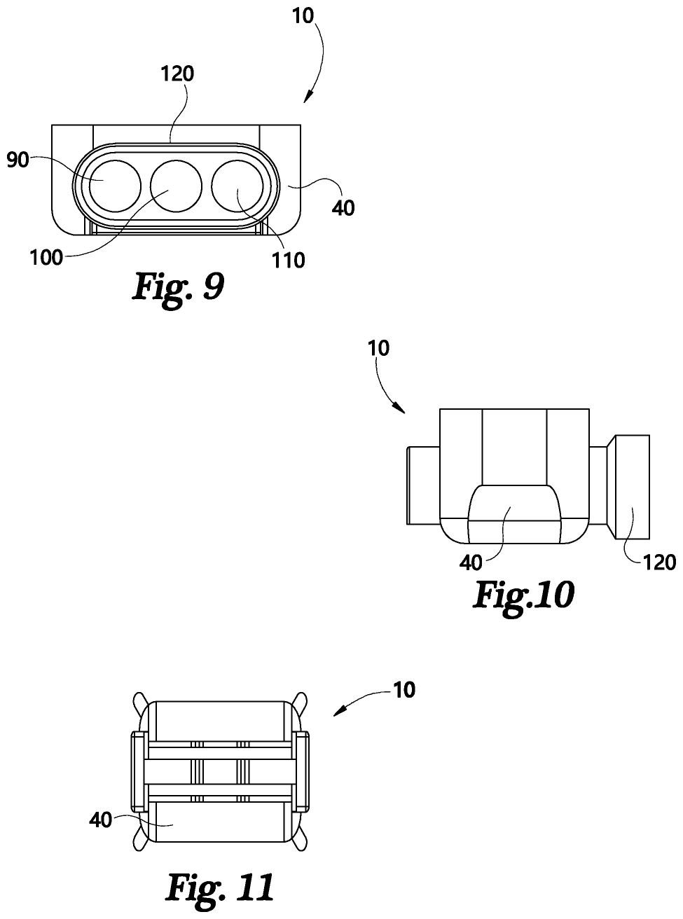

FIG. 9 shows a side view of connector 10. Base 40 does not have top 60 connected to it. Flange 120 provides some protection from outside forces dislodging wires 20, 30. Wire receptacles 90, 100, 110 are openings into which wires 20, 30 may be inserted into base 40. The embodiment shown has three wire receptacles, however, any number of receptacles may be provided depending on the number of wires to be connected. FIG. 10 shows a side view of base 40 and flange 120.

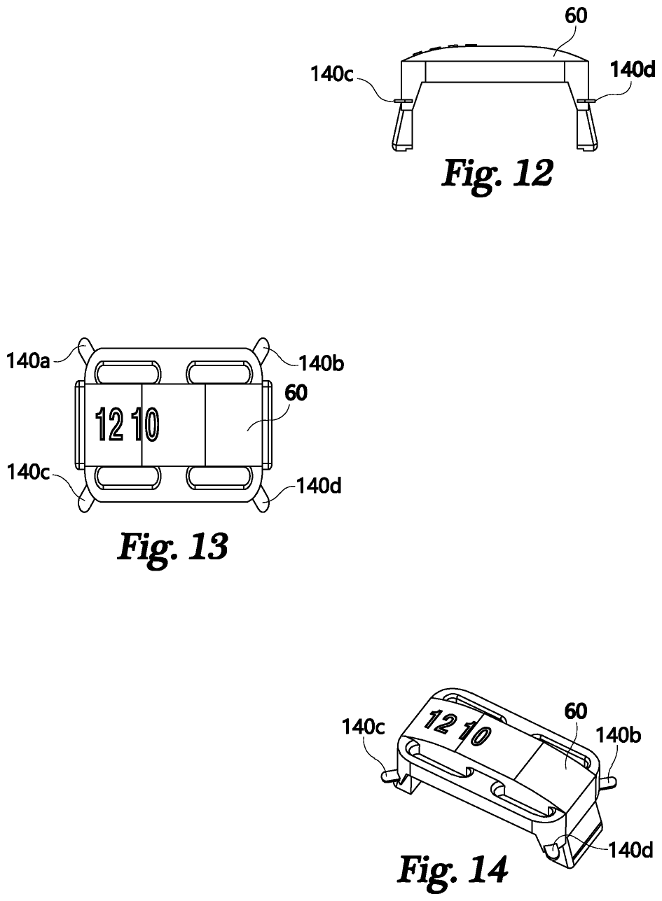

FIG. 11 shows a bottom view of top cover 60. Top cover 60 has legs 140a-d to secure a top 60 to base 40. As shown in FIG. 12, legs 140a-d extend from top 60 and are designed with extrusions to fit complementary structure on base 40 sufficient to allow top 60 to be removably secured to base 40. One skilled in the art will recognize many ways to secure top 60 to base 40 without departing from the scope of this invention.

FIG. 13 shows a top view of top cover 60 comprising legs 140a-d. FIG. 14 shows a perspective view of top 60 with legs 140a-d. Top 60 is configured internally to receive one or more wire connectors 70a-c to allow the wire connectors to connect with wires 20, 30 when top cover 60 is securely attached to base 40.

A hydrophilic gel is dispersed within cavity 130 of base 40 to provide moisture resistance two wires, 20, 30, including the electrical connection between wires 20, 30. The hydrophobic gel can be your various kinds known in the field. Suitable hydrophobic gels include: Dynatex and Super Lube. Any other type of hydrophobic gel such as silicone or similar products may be used within the scope of the disclosed invention. Top the top cover 60 and base 40 may be made from flame retardant nylon, polycarbonate, or any other material that ensures good connectivity and good conductivity for the wires 20, 30 to prevent corrosion and or UV deterioration.

1. A gel filled electrical connector, comprising:
a. a base configured to house a gel fill insulating material and a plurality of 10-gauge or larger diameter wires;
b. the base comprising a plurality of wire receptacles to receive a plurality of wires in a cavity in the base;
c. a top cover sized to be securely and removably attached to the base, wherein the top cover comprises a plurality of wire connectors to strip insulation from the plurality of wire and to electrically connect the plurality of wires;
d. a gel deposited into the cavity to provide moisture resistance to the plurality of wires and plurality of wire connectors, wherein the gel comprises a hydrophobic dielectric.

2. The gel filled electrical connector of claim 1 wherein the base and the cover are formed from a Nylon, a polycarbonate, a plastic, or a resin.

3. The gel filled electrical connector of claim 1 wherein the wire connectors comprise a metal.

4. The gel filled electrical connector of claim 1 wherein the top further comprises a plurality of legs to frictionally engage a plurality of inner walls of the base to allow the top to be secured to the base.

5. (canceled)

6. The gel filled electrical connector of claim 1 wherein the gel comprises silicone.

7. (canceled)

8. A method for providing a moisture-resistant electrical connection between a plurality of wires comprising the steps of:
a. Providing a base and a top cover wherein the top cover may be removably attached to the base;
b. Providing a plurality of wire connectors secured to the top cover;
c. Inserting a plurality of wires through a plurality of wire receptacles into a cavity of the base;
d. attaching the top cover to the base so that the plurality of wire connectors engages and electrically connect the plurality of wires;
e. filling the cavity with a moisture resistant gel, wherein the gel is a hydrophobic dielectric.

9. The method of claim 8 where in the base and the top cover are formed from a Nylon, a polycarbonate, a plastic, or a resin.

10. The method of claim 8 wherein the wire connectors comprise a metal.

11. The method of claim 8 wherein the top cover further comprises a plurality of legs to frictionally engage a plurality of inner walls of the base to allow the top to be secured to the base.

12. (canceled)

13. The method of claim 8 wherein the gel comprises silicone.

14. (canceled)
